(19) United States
(12) Patent Application Publication
(10) Pub. No.: US 2016/0132875 A1
(43) Pub. Date: May 12, 2016

(54) ENHANCEMENT OF MOBILE DEVICE INITIATED TRANSACTIONS

(71) Applicant: GOOGLE INC., Mountain View, CA (US)

(72) Inventors: Ignacio Carlos Blanco, San Francisco, CA (US); Daniel Joseph Talavera, San Francisco, CA (US); Amit Chandak, Milpitas, CA (US)

(73) Assignee: GOOGLE INC., Mountain View, CA (US)

(21) Appl. No.: 14/173,614

(22) Filed: Feb. 5, 2014

(51) Int. Cl. G06Q 20/40

(52) U.S. Cl. CPC G06Q 20/40

(57) ABSTRACT

An account management system receives a payment authorization request from a merchant system for a transaction involving a user. The account management system identifies one or more user accounts associated with the transaction and processes the transaction after sending a payment authorization request to the issuer(s) of the user's financial account(s) and receiving an approval. After receiving a payment request, or shortly thereafter, the user device logs additional transaction data to transmit to the account management system, which uses the data to find a single transaction that correlates with financial transaction data. The account management system creates an enhanced receipt to transmit to the user device by augmenting the financial transaction data and may adjust the merchant information based on location data received from the user device or the payment amount based on an identified merchant type. The account management system updates the enhanced receipt if new information is received.

### TECHNICAL FIELD

This disclosure relates generally to a payment system, and more particularly to methods and systems that provide enhanced receipt data to a user device.

### BACKGROUND

A mobile communication device, such as a mobile phone or a tablet, can be used to complete a payment transaction. Unlike a traditional payment card or device, the mobile communication device has a user interface that makes it convenient for the user to receive feedback or additional information concerning the transaction after its completion. Mobile communication devices are also convenient as payment devices because payment information can be stored on an application, such as a digital wallet application, that communicates with an account management system over a network.

A mobile communication device is capable of logging additional transaction data that is not transmitted in a payment transaction request. However, certain information transmitted in a payment transaction request is not provided to the mobile communication device in a request for payment. Accordingly, the receipt information is limited to the transaction information transmitted in the payment request. Current payment transaction systems also do not provide a way to augment and complement the transaction information with data recorded by the mobile communication device to produce an enhanced transaction receipt.

### SUMMARY

In certain example aspects described herein, a method for enhancing financial transaction data received from a payment transaction using data received from a user device comprises receiving, by a user device, a payment request from a merchant system for a transaction between a user and the merchant system. When the user device receives the payment request the user device logs additional transaction data and transmits the additional transaction data to the account management system. The account management system receives a payment authorization request from a merchant system for the transaction and processes the financial transaction. The account management system also receives the additional transaction data from the user device. The account management system correlates the additional transaction data received from the user device with the financial transaction data received in the payment request to find a corresponding financial transaction. The account management system adjusts or augments the transaction data for the identified transaction to create an enhanced receipt and transmits the enhanced receipt to the user device. The account management system may update the enhanced receipt with new information as it is received.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a receipt enhancement system, in accordance with certain example embodiments.

FIG. 2 is a block diagram depicting a method for transmitting payment information from a user device to a point of sale terminal, in accordance with certain example embodiments.

FIG. 3 is a block diagram depicting a method for processing a financial transaction, in accordance with certain example embodiments.

FIG. 4 is a block diagram depicting a method enhancing receipt data, in accordance with certain example embodiments.

FIG. 5 is a block diagram depicting a method for correlating additional transaction data with financial transaction data received in a payment request to enhance receipt data, in accordance with certain example embodiments.

FIG. 6 is a block diagram depicting a method for identifying a financial transaction that corresponds to data received from a user device, in accordance with certain example embodiments.

FIG. 7 is a block diagram depicting a method for augmenting financial transaction data for an identified financial transaction.

FIG. 8 is a block diagram depicting a computer machine and module, in accordance with certain example embodiments.

### DETAILED DESCRIPTION OF THE EXAMPLE EMBODIMENTS

### Overview

The example embodiments described herein provide computer-implemented techniques for enhancing financial transaction data received from a payment transaction using data received from a user device. In an example embodiment, an account management system receives financial transaction data for a transaction between a user and a merchant system. The account management system also receives additional transaction data logged by the user device. In an example embodiment, the user enables a feature on the user device to allow the device to perform this feature. The account management system correlates the sets of data, adjusts or augments the financial transaction data to create an enhanced receipt, and presents the enhanced receipt to the user device.

A user indicates a desire to complete a financial transaction with a merchant system. A user device and a merchant device establish a communication channel and financial account information is transmitted to the merchant device to complete the financial transaction. A payment authorization request is submitted by the merchant system to an account management system, as the issuer of the financial account information provided by the user device. In an example embodiment, the payment authorization request comprises financial transaction data, such as a merchant name, merchant category code, merchant type, payment amount, counter data, location data, the financial account information, and/or an identification of the user. The account management system identifies one or more financial accounts from a user account maintained by the account management system, submits a new payment authorization request to the issuer(s) of the identified financial account(s), receives notification of an approval of the new payment authorization request, and approves the payment authorization request submitted by the merchant system.

When the user device receives the payment request, or shortly thereafter, the user device logs additional transaction data (for example, location data, counter data, a time stamp, or any other relevant transaction data). In an example embodiment, the user enables a feature on the user device to allow the device to perform this feature. The user device transmits the additional transaction data to the account management system.

The account management system correlates the additional transaction data received from the user device with the financial transaction data received in the payment request to match the additional transaction data to the corresponding financial transaction. For example, the account management system retrieves the user's financial transactions, orders them chronologically, and identifies the financial transactions that occurred within a predefined timeframe of the time stamp data received from the user device. In an example embodiment, the account management system identifies a single transaction match between the sets of data using the time stamp, counter, and/or location data.

The account management system augments the financial transaction data for the identified transaction to create the enhanced receipt. In an example embodiment, the account management system adjusts the merchant name or location based on location data received from the user device. In another example embodiment, the account management system determines the merchant type or classification and adjusts the payment amount by a predefined amount. For example, the user made a purchase from a restaurant merchant, and the account management system adjusts the payment amount by predetermined percentage in anticipation of a tip amount being added to the payment request amount.

The account management system creates an enhanced transaction receipt using adjusted or augmented data and transmits the enhanced receipt to the user device. In an example embodiment, the enhanced receipt is updated with new information as it is received.

### Example System Architecture

Turning now to the drawings, in which like numerals indicate like (but not necessarily identical) elements throughout the figures, example embodiments are described in detail.

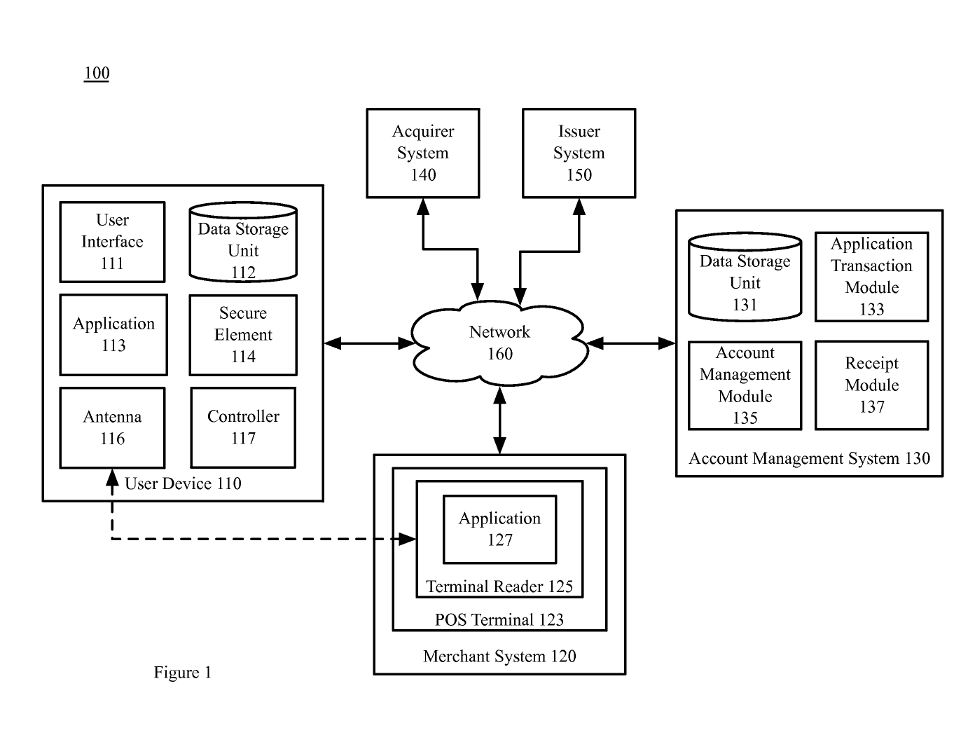

FIG. 1 is a block diagram depicting a receipt enhancement system, in accordance with certain example embodiments. As depicted in FIG. 1, the example operating environment 100 comprises a user device 110, a merchant system 120, an account management system 130, an acquirer system 140, and an issuer system 150 that are configured to communicate with one another via one or more networks 160. In another example embodiment, these systems (including systems 110, 120, 130, 140, and 150) are integrated into the same system. In some embodiments, a user associated with a device must install an application and/or make a feature selection to obtain the benefits of the techniques described herein.

Each network 160 includes a wired or wireless telecommunication means by which network system (including systems 110, 120, 130, 140, and 150) can communicate and exchange data. For example, each network 160 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, near field communication network (NFC), any form of standardized radio frequency, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

Each network system (including systems 110, 120, 130, 140, and 150) includes a device having a communication module capable of transmitting and receiving data over the network 160. For example, each network system (including systems 110, 120, 130, 140, and 150) can comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 160. In the example embodiment depicted in FIG. 1, the network systems (including systems 110, 120, 130, 140, and 150) are operated by a user, merchants, an account management system 130 operator, an acquirer, and an issuer, respectively.

An example user device 110 comprises a user interface 111, a data storage unit 112, an application 113, a controller 117, and an antenna 116. In an example embodiment, the user device 110 may be a personal computer, mobile device (for example, notebook, computer, tablet computer, netbook computer, personal digital assistant (PDA), video game device, GPS locator device, cellular telephone, Smartphone or other mobile device), television, or other appropriate technology that includes or is coupled to a web server, or other suitable application for interacting with web page files. In an example embodiment, the user can use the user device 110 to process payment transactions via a user interface 111 and an application 113. In an example embodiment, the user can use the user device 110 to view enhanced receipt data received from the account management system 130 associated with user payment transactions.

In an example embodiment, the user interface 111 enables the user to interact with the application 113 on the user device 110. For example, the user interface 111 may be a touch screen, a web page, a voice based interface, or any other interface, which allows the user to provide input and receive output from the application 113. In an example embodiment, the user interface 111 enables the user to interact with receipt data received from the account management system 130.

In an example embodiment, the data storage unit 112 comprises any local or remote data storage structure accessible to the user device 110 suitable for storing information. In an example embodiment, the data storage unit 112 stores encrypted information, such as HTML5 local storage. In an example embodiment, the data storage unit 112 is used by the application 113 to store additional transaction details while waiting for a network 160 connection to send the additional transaction details to the account management system 130. In an example embodiment, the data storage unit 112 enables storage of user payment account information and/or an account identifier for the user's account management system 130 account.

In an example embodiment, the application 113 is a program, function, routine, applet, or similar entity that exists on and performs its operations on the user device 110. In some embodiments, the user must install the application 113 and/or make a feature selection on the user device 110 to obtain the benefits of the techniques described herein. In an example embodiment, the user may access and interact with the application 113 on the user device 110 via the user interface 111. In an example embodiment, the application 113 comprises one or more of a shopping application, merchant system 120 application, an Internet browser, a digital wallet application, a loyalty card application, another value-added application, a user interface 111 application, a transaction receipt application, or other suitable application operating on the user device 110. In this same example embodiment, the application 113 communicates the user's financial account information to the merchant system 120 POS terminal 123. In an example embodiment, the application 113 logs a time stamp, location data, and/or counter data in response to receiving a payment request. In an example embodiment, the application 113 communicates additional transaction details comprising the time stamp, the location data, and/or the counter data to the account management system 130. In an example embodiment, the application 113 displays enhanced receipt data received from the account management system 130.

An example user device 110 may comprise a secure element 114 or secure memory, which can exist within a removable smart chip or a secure digital (SD) card or which can be embedded within a fixed chip on the device 110. In certain example embodiments, Subscriber Identity Module (SIM) cards may be capable of hosting a secure element, for example, an NFC SIM Card. The secure element 114 allows a software application 113 resident on the user device 110 and accessible by the device user to interact securely with certain functions within the secure element 114, while protecting information stored within the secure element 114. In an example embodiment, the secure element 114 comprises components typical of a smart card, such as crypto processors and random generators. In an example embodiment, the secure element 114 comprises a Smart MX type NFC controller in a highly secure system on a chip controlled by a smart card operating system, such as a JavaCard Open Platform (JCOP) operating system. In another example embodiment, the secure element 114 is configured to include a non-EMV type contactless smart card, as an optional implementation. The secure element 114 communicates with the application 113 in the user device 110. In an example embodiment, the secure element 114 is capable of storing encrypted user information and only allowing trusted applications to access the stored information. In an example embodiment, a controller 117 interacts with a secure key encrypted application for decryption and installation in the secure element 114.

In an example user device 110, a payment request is processed by the application 113, instead of by a secure element 114. In an example embodiment, the user device 110 communicates payment account information to the merchant system 120 in the form of a proxy or virtual account identifier, without transmitting the user's actual financial account information. The user's actual information is maintained by the account management system 130 instead of within a secure element 114 resident on the user device 110.

In an example embodiment, the antenna 116 is a means of communication between the user device 110 and the terminal reader 125. In an example embodiment, once a user device application 113 has been activated and prioritized, the controller 117 is notified of the state of readiness of the user device 110 for a transaction. The controller 117 outputs through the antenna 116 a radio signal, or listens for radio signals from the terminal reader 125. On establishing a secure communication channel between the user device 110 and the terminal reader 125, the terminal reader 125 requests a payment processing response from the user device 110. An example controller 117 receives a radio wave communication signal from the terminal reader 125 transmitted through the antenna 116. The controller 117 converts the signal to readable bytes. In an example embodiment, the bytes comprise digital information, such as a request for a payment processing response or a request for payment card information. The controller 117 transmits the request to the application 113 for processing.

In an example embodiment, the controller 117 is an NFC controller. In some example embodiments, the controller 117 is a Bluetooth link controller. The Bluetooth link controller may be capable of sending and receiving data, performing authentication and ciphering functions, and directing how the user device 110 will listen for transmissions from the terminal reader 125 or configure the user device 110 into various power-save modes according to the Bluetooth-specified procedures. In another example embodiment, the controller 117 is a Wi-Fi controller or an NFC controller capable of performing similar functions.

In an example embodiment, the user device 110 communicates with the merchant system 120 and the account management system 130. An example merchant system 120 comprises at least one point of sale (POS) terminal 123 that is capable of processing a purchase transaction initiated by a user for example, a cash register. In an example embodiment, the merchant operates a commercial store and the user indicates a desire to make a purchase by presenting a form of payment at the POS terminal 123. In another example embodiment, the merchant operates an online store and the user indicates a desire to make a purchase by clicking a link or “checkout” button on a website. In another example embodiment, the user device 110 is configured to perform the functions of the POS terminal 123. In this example, the user scans and/or pays for the transaction via the user device 110 without interacting with the POS terminal 123.

An example merchant system 120 comprises at least a terminal reader 125 that is capable of communicating with the user device system 120 and a merchant POS terminal 123 via an application 127. The application 127 may be an integrated part of the POS terminal 123, an integrated part of the terminal reader 125, or a standalone hardware device (not shown), in accordance with some example embodiments.

In an example embodiment, the terminal reader 125 is capable of communicating with the user device 110 using an NFC communication method. In another example embodiment, the terminal reader 125 is capable of communicating with the user device 110 using a Bluetooth communication method. In yet another embodiment, the terminal reader 125 is capable of communicating with the user device 110 using a Wi-Fi communication method.

In an example embodiment, the merchant system 120 is capable of communicating with the user device 110 via the terminal reader 125 and/or the application 127. In an example embodiment, the merchant system 120 communicates with the account management system 130 over the network 160. For example, the merchant system 120 communicates a payment authorization request to the account management system 130.

An example account management system 130 comprises a data storage unit 131, an application transaction module 133, an account management module 135, and a receipt module 137.

An example data storage unit 131 comprises any local or remote data storage structure accessible to the user device 110 suitable for storing information. In an example embodiment, the data storage unit 131 stores encrypted information, such as HTML5 local storage. In an example embodiment, the account management system 130 stores financial transaction data in the data storage unit 131. In an example embodiment, the data storage unit 131 includes one or more tangible computer-readable storage devices capable of storing a user's payment account information in association with a user's account. The user may request a purchase from the merchant system 120. In an example embodiment, the purchase is initiated by a wireless “tap” of the user device 120 with the terminal reader 125. The merchant system 120 interacts with the acquirer system 140 (for example Acquirer Payment System Q or other third party payment processing companies) and the issuer system 150 (for example Bank X or other financial institutions to authorize payment) to process the payment. In some example embodiments, the financial account information transmitted by the user device 110 to the terminal reader 125 is a proxy account or a token account that links the payment transaction to a user account maintained by the account management system 130. The payment transaction is routed to the account management system 130 as the issuer system 150 for the proxy account for identification of the user's correct payment card information. In an example embodiment, the application transaction module 133 receives the payment request from the merchant system 120 and interacts with the account management module 135 to identify the user's account management system 130 account and process a payment request to the issuer system 150 of the user's financial account.

An example application transaction module 133 receives payment requests from the merchant system 120 and interacts with the account management module 135 to identify the user's account management system 130 account and process a payment request to the issuer system 150 of the user's financial account. In an example embodiment, the account management module 135 manages a user's account management system 130 account. In an example embodiment, the account management 135 module 135 identifies the user's account and process a payment request to the issuer system 150.

An example receipt module 137 generates augmented receipt data comprising data received from the user device 110 and transaction data. In an example embodiment, the receipt module 137 generates an enhanced receipt by augmenting receipt data and transmits the enhanced receipt to the user device 110. In an example embodiment, the receipt module 137 modifies the merchant information based on location data received from the user device 110 or modifies the payment amount based on an identification of a merchant type or classification. In an example embodiment, the account management system 130 receives updated transaction data, modifies the augmented receipt data, and transmits a new enhanced receipt to the user device 110.

In an example embodiment, the acquirer system 140 interacts with the merchant system 120 and the issuer system 150 to process the payment. For example, the acquirer is a third party payment processing company.

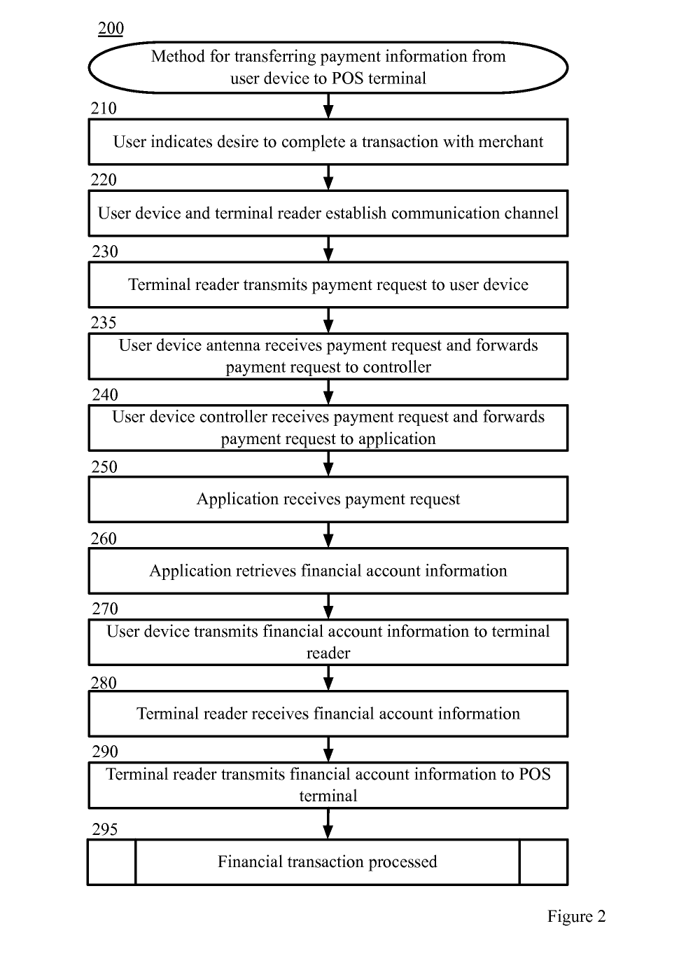

The components of the example-operating environment 100 are described hereinafter with reference to the example methods illustrated in FIGS. 2-7. The example methods of FIGS. 2-7 may also be performed with other systems and in other environments.

### Example System Process

FIG. 2 is a block flow diagram depicting a method 200 for transmitting payment information from a user device 110 to a point of sale (POS) terminal 123. The method 200 is described with reference to the components illustrated in FIG. 1.

A user installs, downloads, or otherwise enables a payment processing application 113, a digital wallet application 113, or other financial transaction application 113 on the user device 110. In an example embodiment, once the user enables the application 113 on the user device 110, the device 110 becomes “authorized”. In this embodiment, an authorized user device 110 is capable of processing a payment transaction, communicating with an account management system 130, and performing the features described herein. In this embodiment, the user device 110 receives financial account information to perform the methods described herein. In an example embodiment, the user can enable the application 113 on more than one user device 110. In this embodiment, each user device 110 may possess the same or different financial account information for use in processing a payment transaction. In another example embodiment, the user can disable or uninstall the application 113 at any time and on any number of previously authorized user devices 110.

In block 210, a user indicates a desire to complete a transaction with a merchant. In an example embodiment, the user accesses an application 113 on the user device 110 and initiates a transaction. For example the application 113 is a merchant shopping application or other application/website that enables the user to perform an electronic financial transaction. In another example, the user accesses a payment processing application 113 that enables the user to wirelessly transmit financial account information to the terminal reader 125. In this example, the financial account information is transmitted via a secure communication channel (for example, near field communications (NFC), Bluetooth, Wi-Fi, or other form of wireless communication channel).

In block 220, the user device 110 and terminal reader 125 establish a communication channel. In an example embodiment, the communication channel is an NFC communication channel. In some example embodiments, the communication channel is a Bluetooth communication channel. In yet another example embodiment, the communication channel is a Wi-Fi communication channel. Accordingly, the payment transaction can be conducted via wireless or “contactless” communication between the user device 110 and the terminal reader 125.

In an example embodiment, the user taps the user device 110 in the proximity of the terminal reader 125. In an example embodiment, the terminal reader 125 generates a radio frequency (RF) or other field polling for the presence of a user device 110, and the user “taps” the user device 110 by placing the device 110 within the field of the terminal reader 125. In some example embodiments, the merchant activates the RF field or other field to poll for the presence of a user device 110 using an application 127 on the terminal reader 125.

In an example embodiment, the terminal reader 125 requests protocols and characteristics from the user device 110 to establish the communication channel. For example, the terminal reader 125 may request the identification of communication protocols (for instance ISO/IEC 14443, MIFARE, and/or ISO/IEC 18092), a list of applications available, and security protocols from the user device 110.

In an example embodiment, the terminal reader 125 transmits a signal requesting a payment processing response to the user device 110. In an example embodiment, the response is a request to proceed with a financial payment transaction. In an example embodiment, the response indicates to the terminal reader 125 that the user device 110 is capable of performing a financial transaction.

In block 230, the terminal reader 125 transmits a payment request to the user device 110. In an example embodiment, the application 127 resident on the merchant system 120 generates the payment request. In an example embodiment, the request is converted to a signal capable of being transmitted to the user device 110 via the communication channel and converted into bytes understandable by the application 127.

In block 235, the user device 110 antenna 116 receives the payment request and forwards the payment request to a controller 117. In an example embodiment, the payment request is transmitted via the communication channel and during the “tap” of the user device 110 with the terminal reader 125. In an example embodiment, the tap is an NFC tap and the controller 117 is an NFC controller.

In block 240, the user device 110 controller 117 receives the payment request and forwards the payment request to the application 113. In an example embodiment, the controller 117 converts the signal received by the antenna 116 into a readable payment request. In an example embodiment, the signal is converted into bytes comprising the readable request. In an example embodiment, the controller 117 transmits the payment request to the application 113. In an example embodiment, the application functions in a manner similar to a secure element or a secure memory during the payment transaction by retrieving stored payment information and providing it to the terminal reader 125 for processing a payment transaction. In another example embodiment, the application is resident in a secure element of a secure memory.

In block 250, the application 113 receives the payment request. In an example embodiment, the request is transmitted through a series of connections before being received by the application. In some example embodiments, the request is transmitted directly from the controller 117 to the application.

In block 260, the application 113 retrieves financial account information. In an example embodiment, the application 113 retrieves financial account information from a digital wallet account associated with the account management system 130.

In block 270, the user device 110 transmits financial account information to the terminal reader 125. In an example embodiment, the information is transmitted in response to the payment request. In an example embodiment, the information is transmitted from the application 113 to the controller 117, where it is converted into a signal understandable by the terminal reader 125 and/or application 127. In an example embodiment, the information is transmitted through the secure communication channel and during the “tap” of the user device 110 with the terminal reader 125.

In block 280, the terminal reader 125 receives the financial account information.

In block 290, the terminal reader 125 transmits the financial account information to the POS terminal 123.

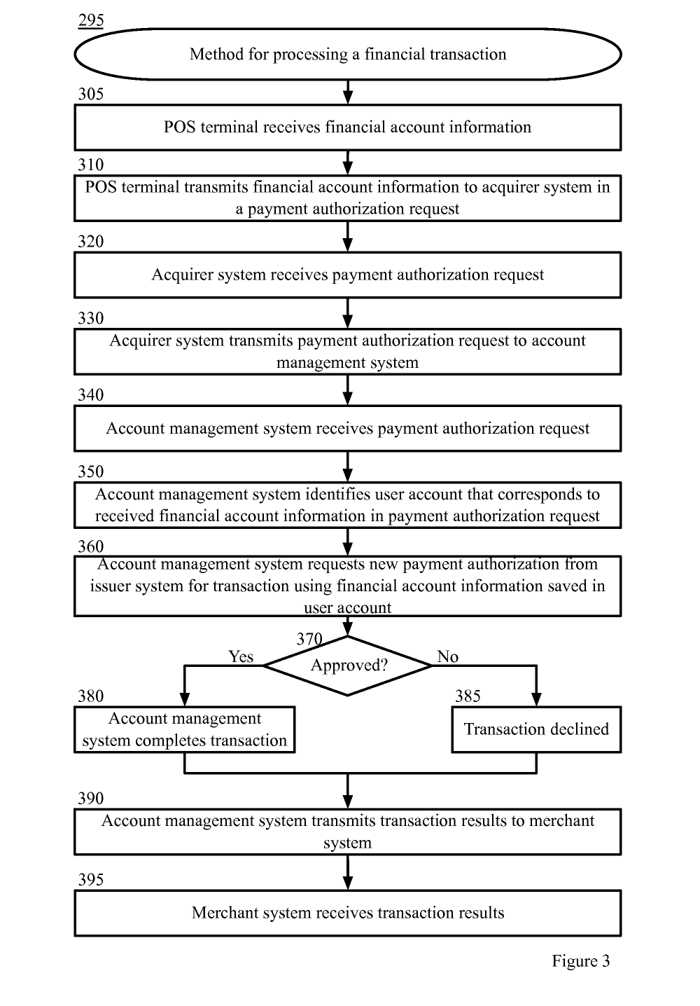

In block 295, the financial transaction is processed. The method for processing a financial transaction is described in more detail hereinafter with reference to the methods described in FIG. 3.

FIG. 3 is a block flow diagram depicting a method 295 for processing a financial transaction, in accordance with certain example embodiments, as referenced in block 295 of FIG. 2. The method 295 is described with reference to the components illustrated in FIG. 1.

In block 305, the POS terminal 123 receives the financial account information. In an example embodiment, the application 113 converts the signal into a language understandable by the merchant system 120. In an example embodiment, the user may be prompted to enter a personal identification number (PIN) into the merchant system 120.

In block 310, the POS terminal 123 transmits the financial account information to an acquirer system 140 in a payment authorization request. In an example embodiment, the merchant's POS terminal 123 submits the request to the acquirer system 140 via a network 160. In an example embodiment, the payment request message comprises the financial account information.

In block 320, the acquirer system 140 receives the payment authorization request.

In block 330, the acquirer system 140 transmits the payment authorization request to an account management system 130. In an example embodiment, the acquirer system 140 automatically makes a determination that routes the financial account information to the account management system 130. In an example embodiment, the determination is made using a series of numbers or routing information in the financial account information. In some example embodiments, the acquirer system 140 and/or card network reviews a list of saved account identification information provided to the by the account management system 130.

In block 340, the account management system 130 receives the payment authorization request.

In block 350, the account management system 130 identifies a user account that corresponds to the received financial account information in the payment authorization request. In an example embodiment, the payment authorization request comprises an account identifier that enables the account management system 130 to identify the user's account. In another example embodiment, the account management system 130 comprises a list of the financial account information for each user and can identifies the user's account by associating this information to the user's financial account information.

In block 360, the account management system 130 requests a new payment authorization from the issuer system 150 for the transaction using financial account information saved in the user's account. In an example embodiment, the account management system 130 identifies the user's saved payment account information. In an example embodiment, the user's digital wallet account contains the rules defined by the user (or the default rules if the user has not modified the default rules). If the user has defined payment rules, the account management system 130 applies the user-defined rules first to determine the order to apply the payment accounts to the transaction. In an example embodiment, the account management system 130 applies the user-defined rules first.

In block 370, the issuer system 150 approves or denies the new payment authorization received from the account management system 130. In some example embodiments, the account management system 130 is the issuer system 150 of the payment account. In this embodiment, the account management system 130 will determine whether sufficient funds are available for the transaction and approve/deny the transaction accordingly.

If new payment request is authorized, the method 295 proceeds to block 380 in FIG. 3. In block 380, the account management system 130 receives notification from the issuer system 150 that the new payment authorization is approved and completes the financial transaction. The account management system 130 logs the approval of the new payment authorization and prepares a notification of the transaction results to transmit to the merchant system 120.

The method 295 then proceeds to block 390 in FIG. 3.

Returning to block 370, if the issuer system 150 denies the new payment authorization, the method 295 proceeds to block 385 in FIG. 3. In block 385, the account management system 130 receives notification from the issuer system 150 that the new payment authorization is declined. The account management system 130 logs the declination of the new payment authorization and prepares a notification of the transaction results to transmit to the merchant system 120.

In block 390, the account management system 130 transmits transaction results to the merchant system 120. In an example embodiment, the issuer system 150 approved the new payment request and the transaction results comprise an approval of the original payment request. In another example embodiment, the issuer system 150 declined the new payment request and the transaction results comprise an declination of the original payment request. In an example embodiment, the transaction results are transmitted to the merchant system 120 through the acquirer system 140.

In block 395, the merchant system 120 receives the transaction results. In an example embodiment, the merchant system 120 completes the financial transaction with the user.

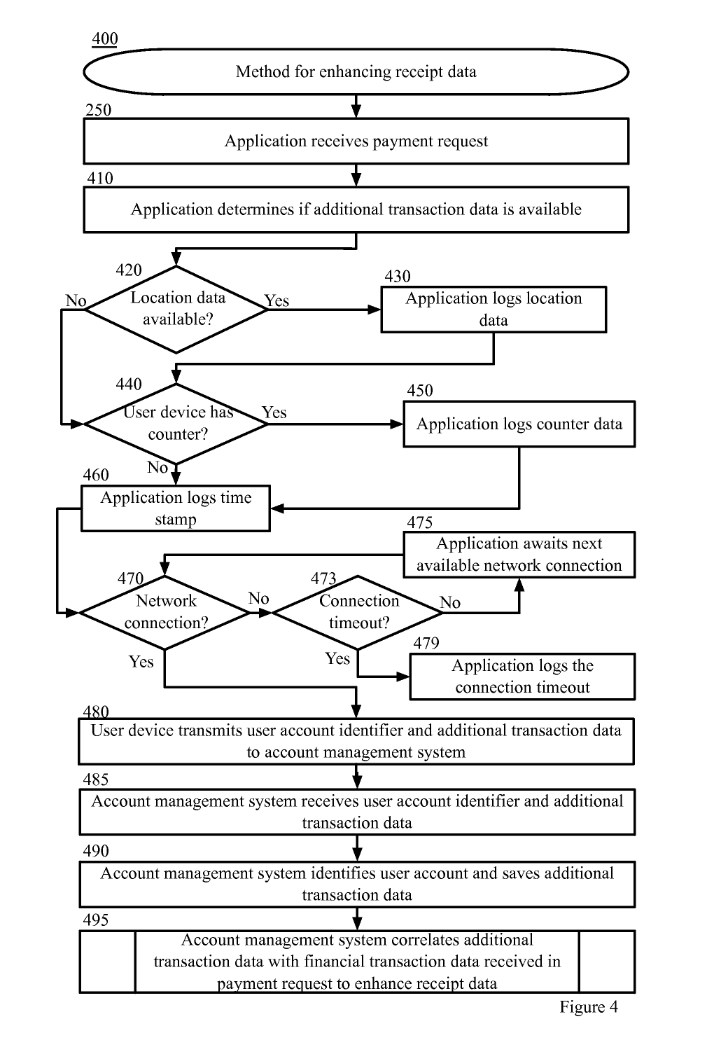

FIG. 4 is a block flow diagram depicting a method 400 for enhancing receipt data, in accordance with certain example embodiments. The method 400 is described with reference to the components illustrated in FIG. 1. In an example embodiment, the method 400 for enhancing receipt data is initiated by the user device 110 in response to receiving a payment request from the merchant system 120. In an example embodiment, the enhancement of receipt data occurs while the financial transaction described in FIGS. 2-3 is processing. In another example embodiment, the enhancement of receipt data occurs at any time after the financial transaction described in FIGS. 2-3 is completed.

In block 250, the application 113 receives the payment request. In an example embodiment, and as described with reference to block 250 in FIG. 2, the user device 110 application 113 receives the payment request from a merchant POS terminal 123 in association with a user-initiated financial transaction. In an example embodiment, the payment request is transmitted via a wireless communication channel from the terminal reader 125 to the antenna 116 of the user device 110, where it is routed through the controller 117 to the application 113.

In block 410, the application 113 determines if additional transaction data is available. In an example embodiment, after receiving the payment request, the application 113 retrieves user financial account information and determines what types, if any, of additional transaction data is available. In an example embodiment, the additional transaction data comprises location data, counter data, a time stamp, offers used in the transaction, rewards used in the transaction, account management system 130 user account identifiers, and any other relevant transaction data. In an example embodiment, the application 113 determines whether the user device 110 is capable of logging and or transmitting the additional transaction data to the account management system 130. In an example embodiment, the user enables a feature on the user device 110 to allow the application 113 to perform this feature. In an example embodiment, the user can disable or unauthorized this feature at any time.

In block 420, the application 113 determines the user device 110 can determine and log location data. In an example embodiment, location data comprises information regarding the physical location of the user device 110, such as an address, longitude and latitude, a location of a network signal or point of interest beacon, a terminal reader 125 or POS terminal 123 location, or any other useful or relevant description of the user device's 110 location. In an example embodiment, the user device 110 is capable of logging location data without user input. For example, the user enables the user device 110 to log the user's location by actuating the user device 110 or application 113 settings. In another example embodiment, the application 113 prompts the user to enter or select the appropriate location data. In yet another example embodiment, the application 113 determines a last known location of the user device 110 or approximates the current location of the user device 110. In an example embodiment, the user enables a feature on the user device 110 to allow the application 113 to perform this feature. In an example embodiment, the user can disable or unauthorized this feature at any time. In another example embodiment, the user device 110 and/or application 113 requests the user's permission to log location data at a time before the location data is logged. For example, the user device 110 requests permission to log location data and the user actuates a user interface 111 object to consent.

If the application 113 determines that location data is available, the method 400 proceeds to block 430. In block 430, the application 113 logs the location of the user device 110. In an example embodiment, the application 113 utilizes the global positioning system (GPS) to log the approximate longitude and latitude of the user device 110. In another example embodiment, the application 113 uses another satellite-based positioning system to log the location data. In yet another example embodiment, the application 113 calculates the distance of the user device 110 from the nearest radio towers or cell towers to determine its position. In an example embodiment, the application 113 logs the location data at the time of the receipt of the payment request. In another example embodiment, the application 113 logs the location concurrently at the time it responds to the payment request. In another example, the user enters a location upon request or the application and/or the user device 110 finds the user's last known location.

The method 400 then proceeds to block 440 in FIG. 4.

Returning to block 420 in FIG. 4, if the application 113 determines that location data is not available, the method 400 proceeds to block 440. For example, if the user device's 110 GPS location system cannot log location data at the moment, the user has not given consent to the user device 110 to log location data, or the user device 110 does not know or cannot use the user's last known location, the user device 110 determines that location data is not available.

In block 440, the application 113 determines whether the user device 110 has a counter. In an example embodiment, the counter is a monotonic counter and thus, only allows for the values to be increased or incremented, not decreased. In an example embodiment, the counter may be implemented in the secure element 114. Counters may store the number of times a particular event or process has occurred. In an example embodiment, the counter assigns alphanumeric characters and/or symbols to information associated with a financial transaction. In an example embodiment, the counter is incremented or assigned after receiving a payment request from a merchant system 120. In an example embodiment, the counter assigned to the payment request is transmitted to the merchant system 120 with the financial account information.

If the application 113 determines that the user device 110 has a counter, the method 400 proceeds to block 450. In block 450, the application 113 logs the counter data. In an example embodiment, the counter comprises an application transaction counter (ATC), which incrementally assigns a number to each transaction after each payment request is received. For example, upon receipt of a payment request, the ATC assigned the previous transaction the number 50. When the application 113 receives current new payment request, the ATC is incremented to 51.

The method 400 then proceeds to block 460 in FIG. 4.

Returning to block 440 in FIG. 4, if the application 113 determines that the user device 110 does not have a counter, the method proceeds to block 460. In another example embodiment, the user device 110 has a counter, but the user has not enabled the counter or the user has not given consent to submit counter data to the account management system 130

In block 460, the application 113 logs a time stamp. In an example embodiment, the time stamp comprises one or more of the current month, day, year, era, time zone, hour of the day, minutes of the hour, and seconds of the minute. For example, a time stamp comprises 9:30 a.m. ET, Dec. 27, 2013.

In block 470, the application 113 determines whether the user device 110 has access to a network 160. In an example embodiment, the user device application 113 communicates with the account management system 130 over the network 160.

If the application 113 determines that the user device 110 does not have access to the network 160, the method 400 proceeds to block 473. In block 473, the application 113 determines whether there has been a connection timeout. For example, a connection timeout occurs when the application 113 attempts multiple times but fails to establish a network 160 connection.

If the application 113 determines that there not been a connection timeout, the method 400 proceeds to block 475. In block 475, the user device 110 awaits the next available network connection before the method 400 proceeds. In an example embodiment, the user device 110 stores the additional transaction data until the user device 110 has access to the network 160. In an example embodiment, the application 113 continues to transmit probing requests and/or attempt to receive probing requests to establish a network 160 connection.

Returning to block 473 in FIG. 4, if the application determines that there has been a connection timeout, the method 400 proceeds to block 479. In block 479, the application 113 logs the connection time out. In an example embodiment, the application 113 does not send or attempt to receive any probing requests to establish a network 160 connection to transmit the additional transaction data unless prompted by the user.

Returning to block 470 in FIG. 4, if the application 113 determines that the user device 110 has access to the network 160, the method 400 proceeds to block 480. In block 480, the user device 110 transmits the additional transaction data to the account management system 130. In an example embodiment, the additional transaction data comprises an account identifier for the user's account management system 130 account.

In block 485, the account management system 130 receives the additional transaction data.

In block 490, the account management system 130 identifies the user account and saves the additional transaction data. In an example embodiment, the account management system 130 identifies the user account via the account identifier. In an example embodiment, the account management system 130 saves the additional transaction data in the user's account management system 130 account.

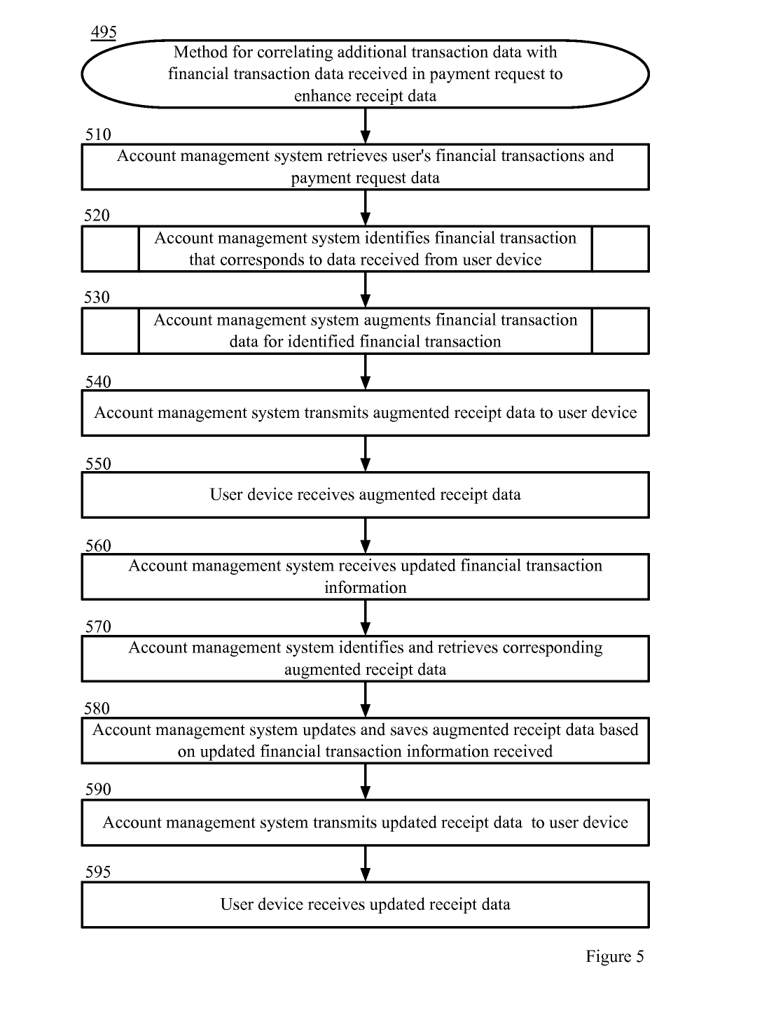

In block 495, the account management system 130 correlates the additional transaction data received from the user device 110 with financial transaction data received in the payment request to create an enhance receipt for the transaction. The method 495 for correlating the additional transaction data with financial transaction data received in the payment request to enhance the receipt data is described in more detail hereinafter with reference to the methods described in FIG. 5.

FIG. 5 is a block flow diagram depicting a method 495 for processing a financial transaction, in accordance with certain example embodiments, as referenced in block 495 of FIG. 4. The method 495 is described with reference to the components illustrated in FIG. 1.

In block 510, the account management system 130 retrieves the user's financial transactions. In an example embodiment, after receiving the additional transaction data from the user device 110, the account management system 130 retrieves the financial transactions and payment request data from the user's account management system 130 account. In an example embodiment, the account management system 130 retrieves the pre-defined number of financial transactions. In another example embodiment, the account management system 130 retrieves any financial transaction that occurred within a pre-defined window of time from receiving the additional transaction data or from a time or date indicated in the additional transaction data.

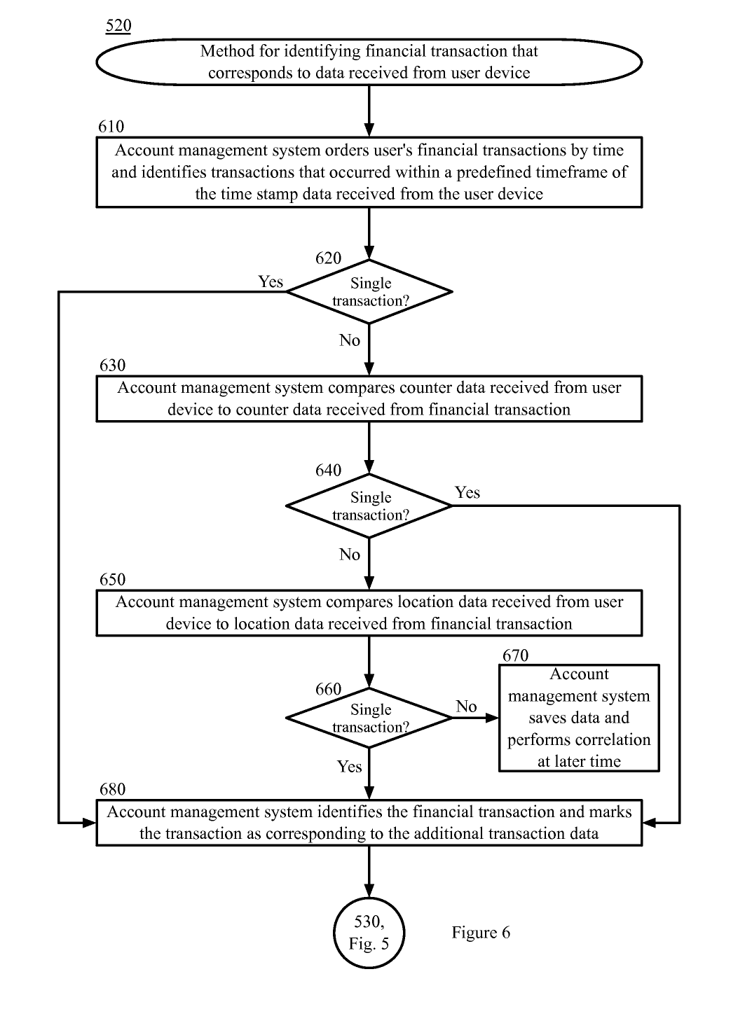

In block 520, the account management system 130 identifies the financial transaction that corresponds to the data received from the user device 110. The method 520 for identifying the financial transaction that corresponds to the data received from the user device 110 is described in more detail hereinafter with reference to the methods described in FIG. 6.

FIG. 6 is a block flow diagram depicting a method 520 for identifying the financial transaction that corresponds to the data received from the user device 110, as referenced in block 520 of FIG. 5. The method 520 is described with reference to the components illustrated in FIG. 1.

In block 610, the account management system 130 orders the user's financial transactions by time and identifies transactions that occurred within a predefined timeframe of the time stamp data received from the user device 110. In an example embodiment, the user's financial transactions comprise transaction data received by the account management system 130 from one or more merchant systems 120 for one or more different financial transactions. In an example embodiment, the transaction data for each financial transaction comprises a payment amount, a time the financial transaction occurred, an identification of the merchant system 120, a merchant category code or type, and any other relevant or useful information concerning the financial transaction.

In an example embodiment, the time stamp data received from the user device 110 is used a reference point to search for financial transactions that occurred within a pre-defined window of time. For example, the account management system 130 identifies transactions that occurred within five hours before and/or after the time stamp. In an example embodiment, the account management system 130 expects the time stamp of the financial transaction to be a certain amount of time before or after the time stamp data transmitted by the user device 110.

In an example embodiment, more than one financial transaction occurred during the pre-defined window of time, and the account management system 130 orders the financial transaction based on the time the financial transaction occurred. For example, the additional data comprises a time stamp that reads 15:25 ET Jan. 10, 2014. The account management system 130 defines a 5-hour window of time and determines which of the financial transactions occurred within that window of time. The account management system 130 identifies the timeframe as 15:30-20:30 ET Jan. 10, 2014 and determines that two financial transactions occurred during that timeframe. A first financial transaction occurred at 15:30 ET Jan. 10, 2014 and a second financial transaction occurred at 17:00 ET Jan. 10, 2014. The account management system 130 orders the first and second financial transactions based on the time the transactions occurred. In an example embodiment, the account management system 130 can define multiple windows of time to ensure enough financial transactions are identified.

In block 620, the account management system 130 determines if a single financial transaction occurred during the pre-define window of time. In an example embodiment, the account management system 130 searches for a single financial transaction that corresponds to the additional transaction data received from the user device 110.

If the account management system 130 identifies a single financial transaction that based on the time stamp data, the method 520 proceeds to block 680 in FIG. 6.

Returning to block 620, if the account management system 130 does not identify a single transaction based on the time stamp data, the method 520 proceeds to block 630 in FIG. 6. In an example embodiment, if the account management system 130 identifies more than one financial transaction within the pre-defined window of time, the account management system 130 performs additional analysis to determine which financial transaction corresponds to the additional data received from the user device 110. Continuing with the previous example, the additional data comprises a time stamp that reads 15:25 ET Jan. 10, 2014 and the user's financial transactions between the timeframe of 15:30-20:30 ET Jan. 10, 2014 comprises two transactions, a first financial transaction occurring at 15:30 ET Jan. 10, 2014 and a second financial transaction occurring at 17:00 ET Jan. 10, 2014. Depending on the time that the user device 110 logs the time stamp, either the first transaction or the second transaction could be the user transaction corresponding to the received additional transaction data.

In block 630, the account management system 130 compares the counter data received from the user device 110 to counter data in each of the identified financial transactions. In block 640, the account management system 130 determines if a single financial transaction matches the counter data received from the user device 110 in the additional transaction data. In an example embodiment, the user device 110 transmits the counter data logged by the application 113 with the financial account information to the merchant system 120. In an example embodiment, the merchant system 120 transmits this counter data in the payment authorization request.

If the account management system 130 identifies a single financial transaction that based on the counter data, the method 520 proceeds to block 680 in FIG. 6.

Returning to block 640, if the account management system 130 does not identify a single financial transaction based on the counter data, the method 520 proceeds to block 650. In block 650, the account management system 130 compares location data received from the user device 110 to location data received from the financial transaction.

If the account management system 130 does not identify a single financial transaction based on the location data, the method 520 proceeds to block 670 in FIG. 6. In block 670, the account management system 130 saves the data and repeats the methods described in FIG. 6 at a later time. In an example embodiment, the account management system 130 marks each financial transaction with the corresponding additional transaction data. In this embodiment, the account management system 130 can determine that one or more of the identified financial transactions correspond to a different set of additional data. Accordingly, the account management system 130 can determine which financial transaction corresponds to the additional transaction data by eliminating possible matches. In another example embodiment, the account management system 130 uses any other suitable means of correlating the financial transaction with the additional transaction data.

In other example embodiments, the account management system 130 identifies the financial transaction that corresponds to the additional transaction data using the time stamp, counter data, location data, or any other suitable data in no particular order, or in an order different than the example embodiments described herein.

Returning to block 660, if the account management system 130 identifies a single transaction based on the location data, the method 520 proceeds to block 680 in FIG. 6. In block 680, the account management system 130 identifies the financial transaction and marks the transaction as corresponding to the additional transaction data.

The method 495 then proceeds to block 530 in FIG. 5.

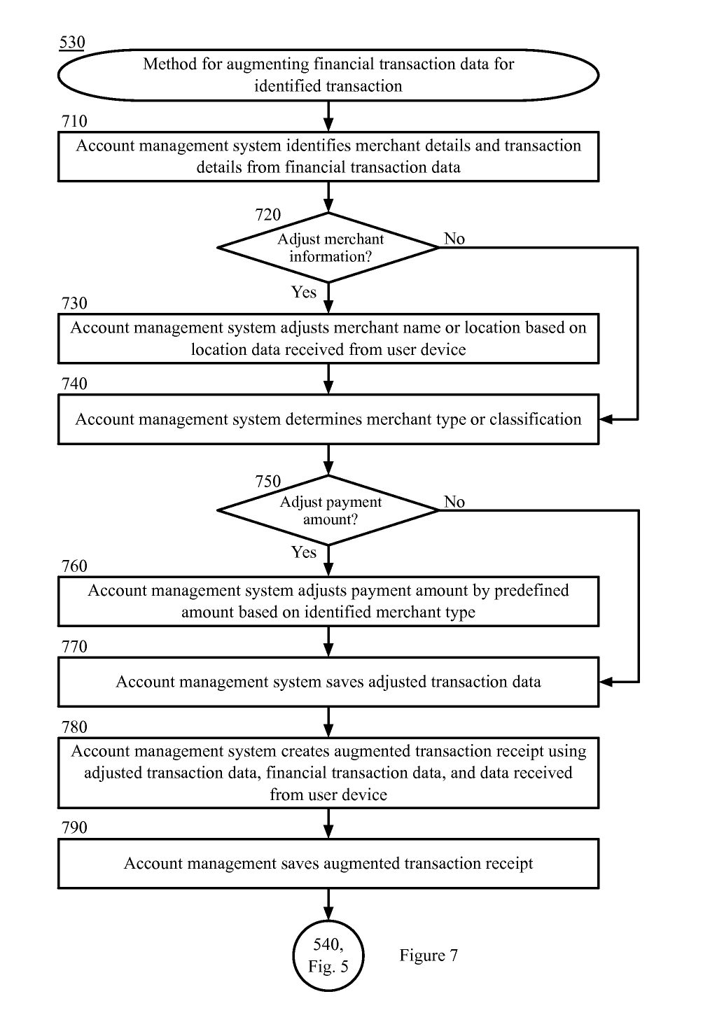

Returning to FIG. 5, in block 530, the account management system 130 augments the financial transaction data for the identified financial transaction. The method 530 for augmenting the financial transaction data for an identified financial transaction is described in more detail hereinafter with reference to the methods described in FIG. 7.

FIG. 7 is a block flow diagram depicting a method 530 for augmenting the financial transaction data for an identified financial transaction, as referenced in block 530 of FIG. 5. The method 530 is described with reference to the components illustrated in FIG. 1.

In block 710, the account management system 130 identifies merchant details and transaction details from the financial transaction data. In an example embodiment, the account management system 130 identifies further useful information from the financial transaction data to be used for the purposes of generating an enhanced receipt. In an example embodiment, the account management system 130 uses a merchant identifier or merchant name to identify a merchant profile that comprises further merchant information.

In block 720, the account management system 130 determines whether to adjust the merchant information. In an example embodiment, the payment authorization request comprises a merchant name, a merchant identifier, a merchant type, and/or a merchant location. The account management system 130 determines whether name or other information identifying the merchant can be adjusted or augmented based on information known to the account management system 130. For example, the merchant name provided in the payment authorization request is a franchisee name (for example, Franchisee XYZ). The account management system 130 determines that Franchisee XYZ corresponds to chain restaurant ABC at location Y based on the location data provided by the user device 110.

In another example, a merchant with the same name has many locations at various physical addresses. In this example, the account management system 130 can use the location data received from the user device 110 to determine at which of a merchant's locations the transaction occurred.

In another example, the payment authorization request comprises out of date location data. In this example, the location data received from the user device 110 can be used to actualize the location of the merchant.

In yet another example, the merchant name in the payment authorization request is in an inferior format or format not likely to be understood by the user (for example, the merchant name listed in the payment authorization request is “first name, last name”). The account management system 130 determines that the merchant name is “Last Name Investments, Inc.”

In an example embodiment, the payment request transmitted to the user device 110 by the merchant system 120 comprises additional data that is not transmitted in the payment authorization request. For example, the additional data may comprise a complete merchant name, address, POS terminal 123 device identification, an account management system 130 identifier that corresponds to the merchant system 120, or other information requested by the user device 110 or useful to the user device 110 in facilitating the financial transaction.

In an example embodiment, the user device 110 logs and transmits location data that corresponds to a merchant location data known to account management system 130. In this embodiment, the account management system 130 augments or adjusts the merchant location or merchant information in the transaction data based on the location data logged by user device 110. In another example embodiment, the account management system 130 augments or adjusts the merchant location or merchant information in the transaction data based on information received over the network 160 from any third party system (for example the acquirer system 140, the issuer system 150, or any third party cloud service provider).

If the account management system 130 determines not to adjust the merchant information, the method 530 proceeds to block 740 in FIG. 7.

Returning to block 720, if the account management system 130 determines to adjust the merchant information, the method 530 proceeds to block 730. In block 730, the account management system 130 adjusts or augments the merchant name and/or location data.

In an example embodiment, the account management system 130 adjusts the merchant name or location based on location data received from the user device 110. For example, the financial transaction data does not comprise a merchant location and/or merchant name, and, instead comprises a merchant identifier. If the merchant identifier does not correspond to a known merchant name or merchant location, the account management system 130 may use the location data received from the user device 110 to determine the merchant name and location. In another example, the account management system 130 receives a GPS location and/or address from the user device 110, which aids in determining the merchant's name and address corresponding to that location. In an example embodiment, the account management system 130 creates an enhanced financial receipt by adjusting and augmenting the financial transaction data with the adjusted merchant name and/or adjusted merchant location. In another example embodiment, the account management system adjusts the merchant name or location based on data received over the network 160 from any third party system (for example, a third party system could be the acquirer system 140, the issuer system 150, or any third party cloud service provider).

In block 740, the account management system 130 determines the merchant type or classification. In an example embodiment, the merchant type or classification is identified in the payment authorization request (for example, a merchant classification code). In an example embodiment, the merchant classification code corresponds to a known merchant type.

In block 750, the account management system 130 determines whether to adjust the payment amount. In an example embodiment, the determination of whether to adjust the payment amount is based on the identification of the merchant type or classification. For example, the merchant type could be a gas station, a restaurant, or a supermarket. In an example embodiment, the account management system 130 uses the merchant code received in the payment authorization request to identify the merchant type. For example, the account management system 130 comprises a directory or mapping that lists merchant types associated with merchant codes. In another example, the account management system 130 uses location data received from the user device 110 application 113 to determine the merchant type. For example, the account management system 130 receives a GPS location or an address and determines the merchant address. Based on the address, the account management system 130 can determine the merchant type.

In an example embodiment, the payment amount is augmented based on the determined merchant type. For example, for merchants in certain service industries, such as restaurants, it may be customary for users to leave tips in addition to the transaction payment amount. In this example, the tip is customarily added on to the transaction payment amount after the initial transaction is processed by the merchant system 120. In this example, in light of a tipping culture, the account management system 130 may determine to adjust the payment amount in the financial transaction data to reflect an estimated transaction payment amount after the tip calculation.

In another example, with merchants such as gas stations or hotels, it may be customary for the merchant to put a hold on the user's financial account for a certain payment amount pending approval of the transaction by the issuer system 150 to insure that the user has funds to pay for all services rendered. In this example, the account management system 130 may determine to adjust the payment amount in the financial transaction data to reflect a final estimated transaction amount. The final transaction amount may be higher or lower than the hold requested by the merchant.

If the account management system 130 determines not to adjust the payment amount, the method 530 proceeds to block 770 in FIG. 7.

Returning to block 750 in FIG. 7, if the account management system 130 determines to adjust the payment amount, the method 530 proceeds to block 760. In block 760, the account management system 130 adjusts the payment amount by a predefined amount or percentage based on the identified merchant type. For example, if the user made a purchase from a restaurant where it is customary to leave a tip, the account management system 130 will increase the payment amount by X percent in anticipation that the payment amount will be adjusted as a result of the user tip.

In another example, the user purchases gasoline from a gas station and the gas station puts a hold on the user's financial account for a certain amount before the user begins to pump gas. The user finishes pumping gas and the merchant system 120 adjusts the transaction amount to reflect the actual amount that should be paid for the gasoline and sends a new payment authorization request to refund the difference between the actual payment amount and the hold placed on the user's financial account. In this example, the account management system 130 may adjust the hold amount in the financial transaction data for the identified transaction to reflect an estimated final payment amount based on the actual services purchased.

In block 770, the account management system 130 saves the adjusted transaction data in the enhanced receipt. In an example embodiment, the account management system 130 saves the enhanced on the data storage unit 131.

In block 780, the account management system 130 creates an augmented transaction receipt using the adjusted transaction data, the financial transaction data, and the data received from the user device 110. For example, the location data, time stamp data, and counter data received from the user device 110 are combined with the original or adjusted merchant name/code, merchant type, original or adjusted merchant location, and original or adjusted payment amount from the financial transaction data or adjusted transaction data.

In block 790, the account management system 130 saves the augmented transaction receipt. In an example embodiment, the account management system 130 saves the augmented transaction receipt on a data storage unit 131.

The method 495 then proceeds to block 540 in FIG. 5.

Returning to FIG. 5, in block 540, the account management system 130 transmits the augmented receipt data to the user device 110.

In block 550, the user device 110 receives the augmented receipt data.

In block 560, the account management system 130 receives updated financial transaction information. For example, a user pays a bill at a restaurant and writes in a tip on the receipt. After receiving the transaction data and correlating the user device 110 data, the account management system 130 adjusts the payment amount by twenty percent and transmits the provisional payment amount to the user device 110 in the augmented receipt.

In block 570, the account management system 130 identifies and retrieves corresponding augmented receipt data. For example, the account management system 130 accesses the augmented receipt data saved on the data storage unit 131 for the transaction between the user and a merchant restaurant.

In block 580, the account management system 130 updates and saves the augmented receipt data based on the updated financial transaction information received. In the previous example, in which the account management system 130 adjusted the payment amount of the user transaction at the restaurant by twenty percent in anticipation that the user would leave a customary tip, the merchant system 120 notifies the account management system 130 that the actual tip was ten percent instead of twenty percent and transmits the true payment amount in a new payment authorization request. In this same example, the account management system 130 lowers the payment amount in the augmented receipt data to reflect the true payment amount comprising the ten percent tip and saves the updated receipt data.

In block 590, the account management system 130 transmits the updated receipt data to the user device 110.

In block 595, the user device 110 receives the updated receipt data. In an example embodiment, the user device 110 displays the augmented receipt data. In an example embodiment, the user may view augmented receipt data for multiple transactions involving the user device 110. In an example embodiment, the user can search for transactions by merchant, by payment instrument, by merchant type, or by any other available category.

### Other Example Embodiments

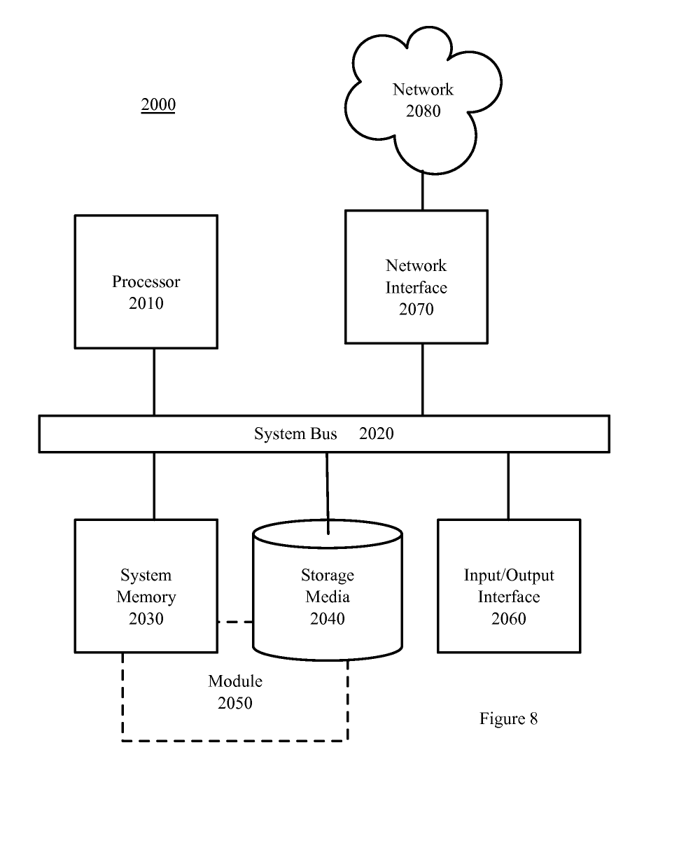

FIG. 8 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method for enhancing financial transaction data, comprising:
receiving, by one or more computing devices, a payment authorization request for a financial transaction between a user and a merchant, wherein the payment authorization request comprises financial transaction data and a financial account identifier, the financial account identifier transmitted by a computing device operated by the user to a computing device operated by the merchant in response to a request for payment;
receiving, by the one or more computing devices and from the computing device operated by the user, additional transaction data for the financial transaction between the user and the merchant, wherein the computing device operated by the user logs the additional transaction data in response to receiving the request for payment from the computing device operated by the merchant;
determining, by the one or more computing devices, that the financial transaction data received in the payment authorization request corresponds to the additional transaction data received from the computing device operated by the user;
communicating, by the one or more computing devices, an approval of the payment authorization request to the merchant;
creating, by the one or more computing devices, an enhanced receipt for the financial transaction, the enhanced receipt comprising augmented financial transaction data, wherein the augmented financial transaction data comprises at least a portion of the financial transaction data received in the payment request and at least a portion of the additional transaction data; and
transmitting, by the one or more computing devices and to the computing device operated by the user, the enhanced receipt.

2. The method of claim 1, wherein the additional transaction data comprises a time stamp, wherein the time stamp indicates a time when the request for payment was received from the computing device operated by the merchant.

3. The method of claim 2, wherein determining that the financial transaction data received in the payment authorization request corresponds to the additional transaction data received from the computing device operated by the user comprises determining, by the one or more computing devices, that a time associated with the financial transaction data is within a predefined window of time of the time stamp.

4. The method of claim 1, wherein the additional transaction data comprises a location of the computing device operated by the user at a time when the request for payment was received from the computing device operated by the merchant.

5. The method of claim 4, wherein determining that the financial transaction data received in the payment authorization request corresponds to the additional transaction data received from the computing device operated by the user comprises determining, by the one or more computing devices, that the location of the computing device operated by the user at the time when the request for payment was received from the computing device operated by the merchant corresponds to a location of the computing device operated by the merchant at a time when the payment authorization request was transmitted.

6. The method of claim 1, wherein the additional transaction data comprises a transaction counter incremented by the computing device operated by the user each time a request for payment is received.

7. The method of claim 6, wherein determining that the financial transaction data received in the payment authorization request corresponds to the additional transaction data received from the computing device operated by the user comprises determining, by the one or more computing devices, that the transaction counter incremented by the computing device operated by the user each time a request for payment is received corresponds to a transaction counter transmitted in the payment request.

8. The method of claim 4, wherein creating the enhanced receipt for the financial transaction further comprises:
determining, by the one or more computing devices, a merchant name by comparing the location of the computing device operated by the user at the time when the request for payment was received from the computing device operated by the merchant with known merchant names; and
wherein the augmented financial transaction data comprises the determined merchant name.

9. The method of claim 1, wherein creating the enhanced receipt for the financial transaction further comprises:
determining, by the one or more computing devices, that the merchant is a merchant type that transmits a payment authorization request for a financial transaction amount that differs from a final financial transaction amount; and
wherein the augmented financial data comprises an adjusted financial transaction amount comprising the financial transaction amount plus a predefined percentage increase.

10. The method of claim 9, wherein the merchant type is a restaurant, food service, gas station, service station, or convenience store.

11. The method of claim 9, further comprising:
receiving, by the one or more computing devices, an updated payment authorization request, wherein the updated payment authorization request comprises an updated financial transaction amount;
creating, by the one or more computing devices, an updated enhanced receipt, wherein the enhanced receipt is updated with the updated financial transaction amount; and
transmitting, by the one or more computing devices, the updated enhanced receipt to the computing device operated by the user.

12. A computer program product comprising:
a non-transitory computer-readable medium having computer-readable program instructions embodied thereon that when executed by a computer cause the computer to enhance financial transaction data, the computer readable instructions comprising:
computer-readable program instructions for receiving a payment authorization request for a financial transaction between a user and a merchant, wherein the payment authorization request comprises financial transaction data and financial account identifier, the financial account identifier transmitted by a computing device operated by the user to a computing device operated by the merchant in response to a request for payment;
computer-readable program instructions for receiving, from the computing device operated by the user, additional transaction data for the financial transaction between the user and the merchant, wherein the computing device operated by the user logs the additional transaction data in response to receiving the request for payment from the computing device operated by the merchant;
computer-readable program instructions for determining that the financial transaction data received in the payment authorization request corresponds to the additional transaction data received from the computing device operated by the user;
computer-readable program instructions for communicating an approval of the payment authorization request to the merchant; and
computer-readable program instructions for creating an enhanced receipt for the financial transaction, the enhanced receipt comprising augmented financial transaction data, wherein the augmented financial transaction data comprises at least a portion of the financial transaction data received in the payment request and at least a portion of the additional transaction data.

13. The computer program product of claim 12, further comprising computer-readable program instructions for transmitting, to the computing device operated by the user, the enhanced receipt.

14. The computer program product of claim 12, wherein the additional transaction data comprises a time stamp, wherein the time stamp indicates a time when the request for payment was received from the computing device operated by the merchant.

15. The computer program product of claim 14, wherein determining that the financial transaction data received in the payment authorization request corresponds to the additional transaction data received from the computing device operated by the user comprises determining that a time associated with the financial transaction data is within a predefined window of time of the time stamp.

16. The computer program product of claim 12, further comprising computer-readable program instructions for:
determining, by the one or more computing devices, that the merchant is a merchant type that transmits a payment authorization request for a financial transaction amount that differs from a final financial transaction amount,
wherein the augmented financial data comprises an adjusted financial transaction amount comprising the financial transaction amount plus a predefined percentage increase;
receiving, by the one or more computing devices, an updated payment authorization request, wherein the updated payment authorization request comprises an updated financial transaction amount;
creating, by the one or more computing devices, an updated enhanced receipt, wherein the enhanced receipt is updated with the updated financial transaction amount; and
transmitting, by the one or more computing devices, the updated enhanced receipt to the computing device operated by the user.

17. A system for enhancing financial transaction data, comprising:
a storage device; and
a processor communicatively coupled to the storage device, wherein the processor executes application code instructions that are stored in the storage device to cause the system to:
receive a payment authorization request for a financial transaction between a user and a merchant, wherein the payment authorization request comprises financial transaction data and financial account identifier, the financial account identifier transmitted by a computing device operated by the user to a computing device operated by the merchant in response to a request for payment;
receive, from the computing device operated by the user, additional transaction data for the financial transaction between the user and the merchant, wherein the computing device operated by the user logs the additional transaction data in response to receiving the request for payment from the computing device operated by the merchant;
determine that the financial transaction data received in the payment authorization request corresponds to the additional transaction data received from the computing device operated by the user;
communicate an approval of the payment authorization request to the merchant; and
create an enhanced receipt for the financial transaction, the enhanced receipt comprising augmented financial transaction data, wherein the augmented financial transaction data comprises at least a portion of the financial transaction data received in the payment authorization request and at least a portion of the additional transaction data.

18. The system of claim 17, wherein the processor is further configured to execute computer-readable program instructions stored in the storage medium to cause the system to transmit, to the computing device operated by the user, the enhanced receipt.

19. The system of claim 17, wherein the additional transaction data comprises a time stamp, wherein the time stamp indicates a time when the request for payment was received from the computing device operated by the merchant.

20. The system of claim 19, wherein determining that the financial transaction data received in the payment authorization request corresponds to the additional transaction data received from the computing device operated by the user comprises determining that a time associated with the financial transaction data is within a predefined window of time of the time stamp.
